(19) United States
(12) Patent Application Publication
(10) Pub. No.: US 2026/0192847 A1
(43) Pub. Date: Jul. 9, 2026

(54) TOUCH AND GESTURE INPUT PANEL FOR A STEERING WHEEL AND A VEHICLE HAVING THE SAME

(71) Applicant: GM GLOBAL TECHNOLOGY OPERATIONS LLC, DETROIT, MI (US)

(72) Inventors: Hyunsung Lim, Seoul (KR); Junhui Park, Incheon (KR); Sitae Yang, Seoul (KR); Philip C. Lundberg, Sylvan Lake, MI (US)

(21) Appl. No.: 19/010,558

(22) Filed: Jan. 6, 2025

(51) Int. Cl. B62D 1/04; G06F 3/01; G06F 3/041; G06V 40/13

(52) U.S. Cl. CPC B62D 1/046; G06F 3/016; G06F 3/0416; G06V 40/13

(57) ABSTRACT

A vehicle includes a steering wheel with a first touch panel configured to receive touch and gesture inputs from a driver. A processing device communicates with the first touch panel to identify commands based on the type of touch and gesture inputs and transmits electrical signals to vehicle systems to execute the commands. The steering wheel may also include a second touch panel, and both panels can be positioned on the rear surface of the steering wheel. The processing device can identify commands based on inputs from both touch panels and the driver's user profile.

### BACKGROUND

The subject disclosure relates to automotive control systems, specifically to touch and gesture input panels integrated into steering wheels.

Modern vehicles are equipped with a wide array of systems that can be controlled by the driver or other occupants. Existing designs for vehicle control interfaces typically rely on physical buttons to manage these various functions. Often, one or more of these physical buttons are strategically located on the steering wheel, allowing the driver to control vehicle systems without removing their hands from the wheel. However, these physical buttons often limit the range of input options to simple, single-function commands. This limitation, combined with the restricted amount of space available on a steering wheel for multiple physical buttons, significantly reduces user convenience and the ability to quickly execute multiple commands.

In addition, current solutions do not allow users to customize input behavior based on touch and gesture, nor do they offer the ability to recognize and process complex input patterns. The lack of such features can result in a less intuitive and less efficient user experience, particularly when users need to perform multiple actions quickly and accurately without diverting their attention from the primary task.

### SUMMARY

According to one aspect of the present invention, a vehicle having a steering wheel having a first touch panel configured to receive touch and gesture inputs from a driver is provided. The vehicle also includes a processing device in communication with the first touch panel. The processing device is configured to identify a command corresponding to the touch and gesture inputs based on a type of the touch and gesture inputs and transmit one or more electrical signals to a vehicle system to execute the command.

According to another aspect, the vehicle includes a steering wheel further comprising a second touch panel configured to receive touch and gesture inputs from the driver.

According to yet another aspect, one or more of the first touch panel and the second touch panel are disposed on a rear surface of the steering wheel.

According to another aspect, the processing device is further configured to identify the command corresponding to touch and gesture inputs based on the type of the touch and gesture inputs received from both the first touch panel and the second touch panel.

According to yet another aspect, the processing device is further configured to identify the driver of the vehicle and to responsively obtain a user profile of the driver.

According to another aspect, the processing device is further configured to identify the command corresponding to touch and gesture inputs based on the user profile.

According to yet another aspect, the steering wheel further includes a third touch panel configured to receive biometric information from the driver that is used by the processing device to identify the driver.

According to another aspect, the first touch panel includes a haptic feedback mechanism that is configured to provide tactile feedback to the driver based on the touch and gesture inputs.

According to yet another aspect, the type of the touch and gesture inputs include at least one of tap, double tap, triple tap, swipe up, swipe down, swipe left, swipe right, tap and hold, and pressure intensity.

According to another aspect, the first touch panel includes a touch grid that is configured to provide the processing device with a location of the touch and gesture inputs on the first touch panel.

According to yet another aspect, a method for controlling one or more systems of a vehicle is provided. The method includes obtaining, via a first touch panel disposed in a steering wheel of the vehicle, touch and gesture inputs from a driver; identifying a command corresponding to the touch and gesture inputs based on a type of the touch and gesture inputs; and transmitting one or more electrical signals to a vehicle system to execute the command.

According to another aspect, the method includes a steering wheel that includes a second touch panel configured to receive touch and gesture inputs from the driver.

According to yet another aspect, one or more of the first touch panel and the second touch panel are disposed on a rear surface of the steering wheel.

According to another aspect, the command is identified based on the type of the touch and gesture inputs received from both the first touch panel and the second touch panel.

According to yet another aspect, the method further includes identifying the driver of the vehicle and responsively obtaining a user profile of the driver.

According to another aspect, the command is identified based at least in part on the user profile.

According to yet another aspect, the steering wheel further includes a third touch panel configured to receive biometric information from the driver.

According to another aspect, the first touch panel includes a haptic feedback mechanism that is configured to provide tactile feedback to the driver based on the touch and gesture inputs.

According to yet another aspect, the type of the touch and gesture inputs include at least one of tap, double tap, triple tap, swipe up, swipe down, swipe left, swipe right, tap and hold, and pressure intensity.

According to another aspect, the first touch panel includes a touch grid that is configured to provide a location of the touch and gesture inputs on the first touch panel.

According to one aspect of the present invention, a vehicle having a steering wheel with a first touch panel and a second touch panel disposed on a rear surface of the steering wheel is provided. The first touch panel and the second touch panel are configured to receive touch and gesture inputs from a driver. The vehicle also includes a processing device in communication with the first touch panel and the second touch panel, where the processing device configured to identify a command corresponding to the touch and gesture inputs based on a type of the touch and gesture inputs and transmit one or more electrical signals to a vehicle system execute the command. The type of the touch and gesture inputs include at least one of tap, double tap, triple tap, swipe up, swipe down, swipe left, swipe right, tap and hold, and pressure intensity.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle equipped with a steering wheel designed to incorporate various control systems;

FIG. 2A illustrates a steering wheel equipped with a first touch panel and a second touch panel;

FIG. 2B shows a steering wheel equipped with first and second touch panels, each including a touch grid;

FIG. 3 depicts a block diagram of a control system integrating touch panels, a processing device, memory, sensors, and vehicle systems;

FIG. 4 illustrates a flowchart diagram of a method for controlling a system of a vehicle using a gesture input panel integrated into a steering wheel; and

FIG. 5 illustrates a flowchart diagram of a method for controlling a system of a vehicle using gesture input panels integrated into a steering wheel.

### DETAILED DESCRIPTION

The following description is merely exemplary in nature and is not intended to limit the present disclosure, its application or uses. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

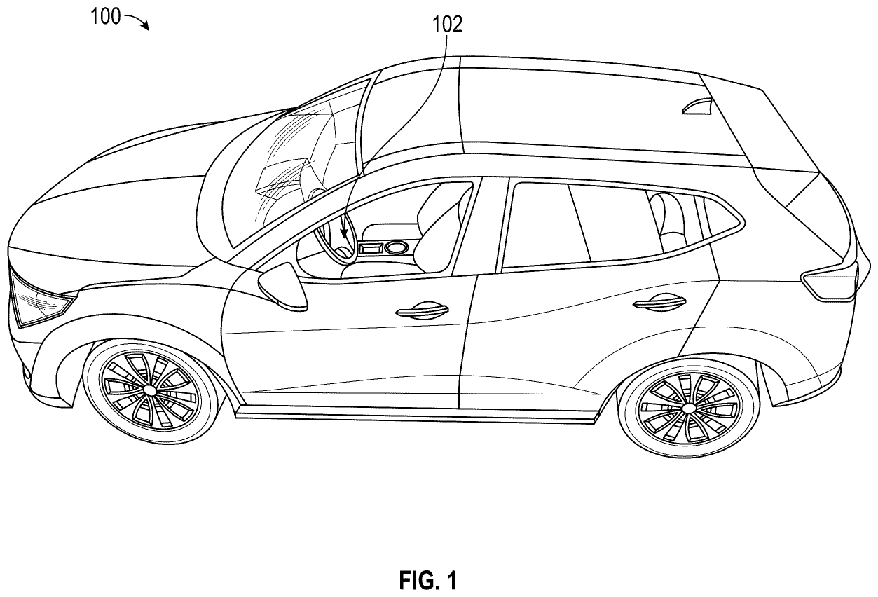

FIG. 1 shows a vehicle 100 equipped with a steering wheel 102. The vehicle 100 is designed to incorporate various control systems that can be managed by the driver of the vehicle. In exemplary embodiments, the steering wheel 102 is integrated into the vehicle 100 and serves as the primary interface for the driver to control the vehicle's direction. The steering wheel 102 also includes additional control features to manage various vehicle systems without requiring the driver to remove their hands from the wheel.

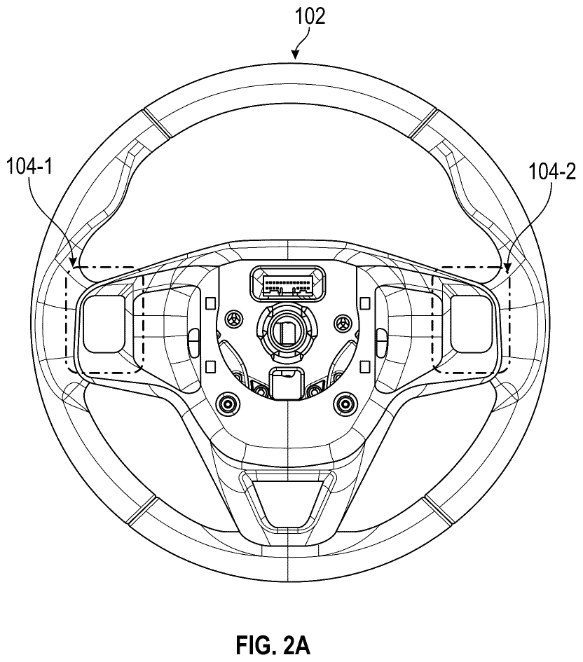

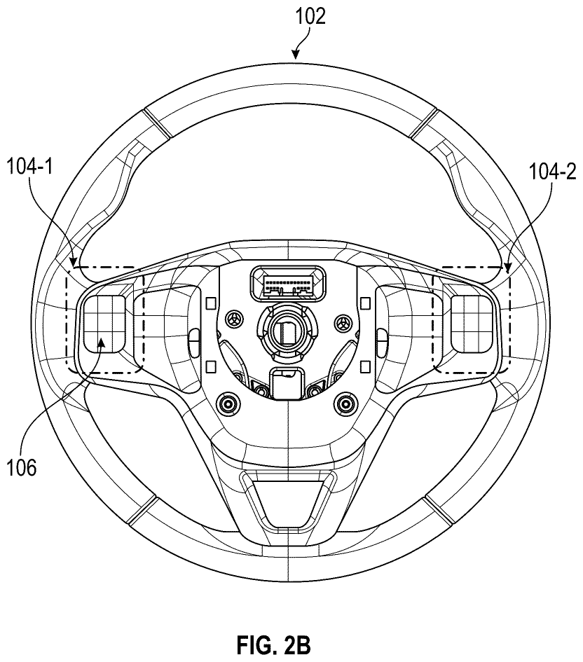

Referring now to FIG. 2A, a rear view of a steering wheel 102 equipped with a first touch panel 104-1 and a second touch panel 104-2 is shown. The steering wheel 102 serves as the primary interface for the driver to control the vehicle's direction and includes additional control features to manage various vehicle systems without requiring the driver to remove their hands from the wheel.

In exemplary embodiments, the steering wheel 102 integrates the first touch panel 104-1 and the second touch panel 104-2, referred to collectively herein as touch panels 104, to enhance the driver's ability to interact with the vehicle's systems. In exemplary embodiments, one or more of the first touch panel 104-1 and the second touch panel 104-2 are disposed on the rear surface of the steering wheel 102. In exemplary embodiments, the first touch panel 104-1 is positioned on the left side of the rear of the steering wheel 102, allowing the driver to perform various touch and gesture inputs. The first touch panel 104-1 can recognize and process complex input patterns, providing a customizable and intuitive user experience. In exemplary embodiments, the second touch panel 104-2 is located on the right side of the rear of the steering wheel 102. Similar to the first touch panel 104-1, the second touch panel 104-2 enables the driver to execute multiple commands quickly and accurately through touch and gesture inputs. The second touch panel 104-2 also supports the recognition and processing of complex input patterns, further enhancing the driver's control over the various systems of the vehicle.

In exemplary embodiments, the touch panels 104 integrated into the steering wheel 102 are designed to detect a variety of touch and gesture inputs. These inputs enable the driver to interact with the vehicle's systems in a more intuitive and efficient manner. The types of inputs that the touch panels can detect include taps, swipes, and presses.

In one example, a single touch on the panel, referred to herein as a tap, can be used to activate the turn signal or answer an incoming phone call. Two quick touches in succession, or a double tap, can toggle between different audio sources or mute the audio system. Three quick touches in succession, referred to as a triple tap, might be used to activate the hazard lights or switch between different driving modes.

In another example, touching the panel and holding one or more of the touch panels 104 for a specified duration, known as tap and hold, can adjust the volume of the audio system or engage the cruise control. Swipes, which are sliding motions across the panel, can be in various directions such as up, down, in, or out. For example, a swipe up can increase the temperature of the climate control system, a swipe down can decrease it, a swipe in towards the center of the steering wheel can navigate to the previous track in a playlist, and a swipe out away from the center can navigate to the next track.

In exemplary embodiments, the touch panels 104 can also detect varying levels of pressure applied by the driver, known as pressure sensitivity; a light press might scroll through menu options, while a harder press could select an option. Additionally, the touch panels can recognize combinations of the above inputs, such as a swipe followed by a tap, which can quickly access a specific function like adjusting the seat position or activating the windshield wipers. These diverse input options allow for a highly customizable and user-friendly interface, enabling drivers to perform multiple actions quickly and accurately without diverting their attention from the primary task of driving.

Referring now to FIG. 2B, a rear view of a steering wheel 102 equipped with a first touch panel 104-1 and a second touch panel 104-2 is shown. As illustrated, one or more of the first touch panel 104-1 and the second touch panel 104-2 include a touch grid 106. In exemplary embodiments, the touch grid 106 is configured to detect a variety of touch and gesture inputs and to precisely detect the location of such inputs, enabling the driver to interact with the vehicle's systems in a more intuitive and efficient manner. The types of inputs that the touch grid 106 can detect include taps, swipes, and presses. In exemplary embodiments, the touch grids 106 can distinguish between a single tap on the left side of a touch panel and a single tap on the right side of the touch panel, thereby allowing the touch panels to receive a wider variety of user input commands.

In one embodiment, the touch grid 106 is integrated into the first touch panel 104-1 of the steering wheel and is designed using a capacitive sensing technology, which allows for precise detection of touch and gesture inputs by measuring changes in capacitance at different points on the grid. This embodiment ensures high accuracy in recognizing the location and type of input, such as taps, swipes, and pressure intensity, providing a responsive and intuitive user interface. In another embodiment, the touch grid 106 is constructed using resistive touch technology, where the grid consists of two conductive layers separated by a small gap. When pressure is applied, the layers make contact, and the exact location of the touch is determined by measuring the resistance at the contact point. This embodiment is particularly useful in environments where the touch panel may be exposed to contaminants or moisture, as resistive touch technology is less affected by such conditions. Additionally, the touch grid 106 can be implemented using an optical sensing method, where an array of light sensors and emitters are embedded within the touch panel. This configuration detects interruptions in the light beams caused by touch or gesture inputs, allowing for precise location tracking and gesture recognition. This optical sensing embodiment enhances the touch panel's ability to detect complex gestures and provides a robust solution for high-precision applications. Furthermore, the touch grid can be designed with a haptic feedback mechanism that provides tactile sensations to the driver, confirming the receipt of commands through vibrations or other tactile responses. This feature enhances the user experience by providing immediate feedback, ensuring that the driver can interact with the vehicle's systems confidently and without needing to divert their attention from driving. Each of these embodiments demonstrates the adaptability of the touch grid 106 technology within the legal and functional scope defined by the patent claims, offering various solutions to meet different operational requirements and user preferences.

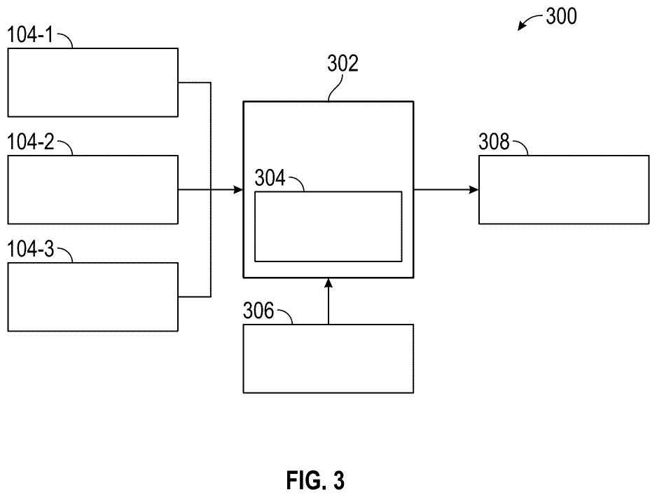

Referring now to FIG. 3, a block diagram of a control system 300 of a vehicle in accordance with an exemplary embodiment is shown. The control system 300 integrates multiple components to facilitate the touch and gesture input functionality within the vehicle. The control system 300 includes a first touch panel 104-1, a second touch panel 104-2, a third touch panel 104-3, a processing device 302, a memory 304, sensor(s) 306, and the vehicle systems 308.

In exemplary embodiments, the first touch panel 104-1 is mounted on the rear of the left side of the steering wheel 102. The first touch panel 104-1 detects various touch and gesture inputs from the driver, such as taps, swipes, and pressure-based inputs. The first touch panel 104-1 communicates these inputs to the processing device 302 for further processing and execution of commands. The first touch panel 104-1 can recognize complex input patterns, enabling a customizable and intuitive user experience.

In exemplary embodiments, the second touch panel 104-2 is positioned on the rear of the right side of the steering wheel 102. Similar to the first touch panel 104-1, the second touch panel 104-2 detects touch and gesture inputs, including taps, swipes, and pressure-based inputs. The second touch panel 104-2 sends these inputs to the processing device 302 for processing. The second touch panel 104-2 supports the recognition and processing of complex input patterns, enhancing the driver's control over the vehicle's systems.

In exemplary embodiments, a third touch panel 104-3 is an additional touch panel that is mounted on the front of the steering wheel 102. In one embodiment, the third touch panel 104-3 can be used to detect touch and gesture inputs and communicate these inputs to the processing device 302. In addition, the third touch panel 104-3 may be configured to detect biometric information, such as a fingerprint of the user. In exemplary embodiments, the biometric information may be used to determine the identity of the user and to select a stored user profile that corresponds to the user. In an exemplary embodiment, the stored user profile of a user includes a mapping between various touch inputs on the touch panels and the corresponding commands.

In exemplary embodiments, the processing device 302 is a central component that receives input signals from the first touch panel 104-1, the second touch panel 104-2, and the third touch panel 104-3. The processing device 302 processes these signals and converts them into the appropriate electrical signals. The processing device 302 then sends these electrical signals to the appropriate vehicle systems 308 for execution. The processing device 302 ensures that the touch and gesture inputs are accurately interpreted and executed in real-time.

In exemplary embodiments, the memory 304 is in communication with the processing device 302 and stores software, firmware, and data necessary for the operation of the touch and gesture input system. For example, the memory 304 may store one or more user profiles that map various gesture patterns to corresponding commands. The memory 304 may also include predefined functions, gesture patterns, and customization settings that the processing device 302 uses to process input signals.

In exemplary embodiments, the touch panels include various sensors that are integrated into the touch panels to detect various input types, such as touch, pressure, and gestures. In addition, the control system 300 includes sensor(s) 306 that are configured to collect other data regarding the vehicle and/or the driver. These sensors 306 provide real-time data to the processing device 302. The sensor(s) 306 can be used to monitor the operating condition of the vehicle, the location of the vehicle, the identity of the occupants of the vehicle, and the operating conditions of various vehicle systems 308.

In exemplary embodiments, the vehicle systems 308 are the various systems within the vehicle that can be controlled through the touch and gesture input panels. The vehicle systems 308 include, but are not limited to, the turn signal, hazard lights, audio system, telephone functions, air conditioning control unit, window control unit, infotainment system, the heating and cooling system of the vehicle, the autonomous drive systems of the vehicle, and the like. The processing device 302 sends electrical signals to the vehicle systems 308 based on the input received from the touch panels, enabling the driver to control these systems without removing their hands from the steering wheel.

In one embodiment, the second touch panel 104-2, positioned on the right side of the steering wheel 102, is designed to detect various touch and gesture inputs to control the vehicle's audio system, either by default or based on the user profile of the driver. When the driver performs a single finger swipe up on the second touch panel 104-2, the touch panel detects this input and sends a signal to the processing device 302. The processing device 302 processes the input and generates an electrical signal corresponding to the “increase volume” command. This signal is then sent to the audio system, which increases the volume of the audio output accordingly. Similarly, when the driver performs a single finger swipe down on the second touch panel 104-2, the touch panel detects this input and sends a signal to the processing device 302. The processing device 302 processes the input and generates an electrical signal corresponding to the “decrease volume” command. This signal is then sent to the audio system, which decreases the volume of the audio output accordingly.

When the driver performs a single finger swipe right on the second touch panel 104-2, the touch panel detects this input and sends a signal to the processing device 302. The processing device 302 processes the input and generates an electrical signal corresponding to the “skip forward” command. This signal is then sent to the audio system, which skips to the next track or audio file in the playlist. Conversely, when the driver performs a single finger swipe left on the second touch panel 104-2, the touch panel detects this input and sends a signal to the processing device 302. The processing device 302 processes the input and generates an electrical signal corresponding to the “skip backward” command. This signal is then sent to the audio system, which skips to the previous track or audio file in the playlist.

Additionally, when the driver performs a tap on the second touch panel 104-2, the touch panel detects this input and sends a signal to the processing device 302. The processing device 302 processes the input and generates an electrical signal corresponding to the “pause” command. This signal is then sent to the audio system, which pauses the audio output.

In another embodiment, the second touch panel 104-2, positioned on the right side of the steering wheel 102, is designed to detect various touch and gesture inputs to control the vehicle's autonomous driving functions. When the vehicle is in a hands-free driving mode, the second touch panel 104-2 enables the driver to interact with the vehicle's autonomous systems without removing their hands from the steering wheel, providing a seamless and intuitive user experience. When the driver performs a double finger swipe up on the second touch panel 104-2, the touch panel detects this input and sends a signal to the processing device 302. The processing device 302 processes the input and generates an electrical signal corresponding to the “increase speed” command. This signal is then sent to the vehicle's autonomous driving system, which increases the speed of the vehicle accordingly. Similarly, when the driver performs a double finger swipe down on the second touch panel 104-2, the touch panel detects this input and sends a signal to the processing device 302. The processing device 302 processes the input and generates an electrical signal corresponding to the “decrease speed” command. This signal is then sent to the vehicle's autonomous driving system, which decreases the speed of the vehicle accordingly.

When the driver performs a double finger swipe right on the second touch panel 104-2, the touch panel detects this input and sends a signal to the processing device 302. The processing device 302 processes the input and generates an electrical signal corresponding to the “change lane to the right” command. This signal is then sent to the vehicle's autonomous driving system, which instructs the vehicle to change lanes to the right. Conversely, when the driver performs a single finger swipe left on the second touch panel 104-2, the touch panel detects this input and sends a signal to the processing device 302. The processing device 302 processes the input and generates an electrical signal corresponding to the “change lane to the left” command. This signal is then sent to the vehicle's autonomous driving system, which instructs the vehicle to change lanes to the left.

Additionally, when the driver performs a tap on the second touch panel 104-2, the touch panel detects this input and sends a signal to the processing device 302. The processing device 302 processes the input and generates an electrical signal corresponding to the “exit hands-free driving mode” command. This signal is then sent to the vehicle's autonomous driving system, which exits the hands-free driving mode and returns control of the vehicle to the driver. These touch and gesture inputs on the second touch panel 104-2 allow the driver to control the vehicle's autonomous driving functions efficiently and intuitively, enhancing the overall driving experience by enabling quick and accurate execution of commands without diverting attention from the primary task of driving.

In exemplary embodiments, the types of controls available through the touch panels 104 can be highly customizable and are based on a combination of inputs, vehicle operating conditions, and user profiles. The touch panels can detect various touch and gesture inputs, such as taps, swipes, and pressure-sensitive touches, allowing for a wide range of control options. These inputs can be combined in different ways to execute specific commands, providing a flexible and intuitive user interface. Additionally, the control system 300 can take into account the current operating conditions of the vehicle. For example, certain controls may be enabled or disabled based on the vehicle's speed, whether it is in hands-free driving mode or other real-time conditions. This ensures that the controls are contextually appropriate and enhances safety and usability. User profiles further enhance the customization of the control system. Each user can have a personalized profile that maps specific touch and gesture inputs to their preferred commands. The system can recognize the user through biometric information or other identification methods and automatically load the corresponding user profile. This allows for a tailored user experience, where the controls are optimized for the individual preferences and habits of each driver. By combining these elements (input types, vehicle operating conditions, and user profiles) the touch panel control system offers a highly adaptable and user-friendly interface that enhances the overall driving experience.

In one embodiment, the touch panel system for a steering wheel includes a first touch panel mounted on the rear surface of the steering wheel, designed to receive various touch and gesture inputs from the driver. This touch panel is equipped with a haptic feedback mechanism that provides tactile feedback to the driver based on the inputs, enhancing the user experience by confirming the receipt of commands through vibrations or other tactile sensations. In another embodiment, the system incorporates an optical sensor integrated into the touch panel to improve the accuracy of gesture recognition, ensuring precise detection and processing of complex input patterns.

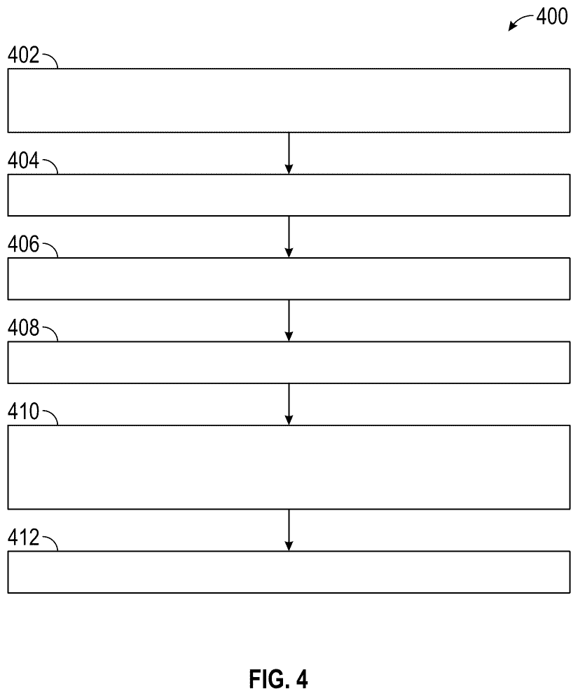

Referring now to FIG. 4, a flowchart diagram of a method 400 for controlling a system of a vehicle using a gesture input panel integrated into a steering wheel in accordance with an exemplary embodiment is shown. The method 400 begins at block 402 by detecting a first input gesture on a first touch panel on the steering wheel of a vehicle. In exemplary embodiments, the first touch panel 104-1 is integrated into the steering wheel 102 and is designed to detect various touch and gesture inputs from the driver. These inputs can include taps, swipes, and pressure-based gestures. The first touch panel 104-1 communicates the detected input gesture to the processing device 302 for further processing and execution of commands.

Next, at block 404, method 400 includes determining the operating condition of the vehicle. In exemplary embodiments, the processing device 302 receives data from various sensor(s) 306 integrated into the vehicle to determine the operating condition of the vehicle. These sensors 306 monitor real-time data such as vehicle speed, engine status, location, and other operational parameters. The processing device 302 uses this data to determine the current operating condition of the vehicle, which is necessary for contextually appropriate command execution.

Following the determination of the vehicle's operating condition, the method 400 proceeds to block 406 and includes determining the identity of the driver of the vehicle. In exemplary embodiments, a third touch panel 104-3 can be configured to detect biometric information such as a fingerprint. This biometric data is used to identify the driver. The processing device 302 processes the biometric information to determine the driver's identity and retrieve the corresponding user profile from the memory 304.

In other embodiments, the identity of the driver can be determined through various other methods. Facial recognition can be employed, where cameras integrated into the vehicle's interior capture the driver's facial features and advanced facial recognition algorithms analyze these features to identify the driver accurately. Voice recognition is another method, where the vehicle is equipped with microphones and voice recognition software that can identify the driver based on their unique voice patterns. The driver may be prompted to speak a specific phrase or command, which the system uses to verify their identity. The vehicle can also recognize the driver based on the unique signal from their key fob or a paired smart device, such as a smartphone or smartwatch. When the driver enters the vehicle with the recognized device, the system can automatically identify them. Additionally, the vehicle can use sensors to detect the seat position and other personalized settings, such as mirror adjustments and climate control preferences. By comparing these settings with stored profiles, the system can identify the driver. RFID or NFC tags can also be used, where the driver carries a tag that the vehicle's sensors can detect. When the driver enters the vehicle, the system reads the tag and identifies the driver based on the unique identifier associated with the tag. Furthermore, the vehicle can analyze the driver's unique behavioral patterns, such as their driving style, the way they interact with the touch panels, or their typical routes. By comparing these patterns with stored profiles, the system can identify the driver. These various methods can be used individually or in combination to accurately determine the identity of the driver, ensuring a personalized and secure driving experience.

Once the driver's identity is determined, the method 400 proceeds to block 408 and includes obtaining a user profile for the driver. In exemplary embodiments, the memory 304 stores user profiles that include mappings between various touch and gesture inputs and their corresponding commands. The processing device 302 retrieves the user profile associated with the identified driver. This user profile allows the system to customize the touch and gesture input behavior based on the driver's preferences and habits.

The method 400 then proceeds to block 410 and determines a command corresponding to the first input gesture based on one or more of a type of the first input gesture, the operating condition of the vehicle, and the user profile. In exemplary embodiments, the processing device 302 analyzes the first input gesture detected by the first touch panel 104-1, taking into account the current operating condition of the vehicle and the retrieved user profile. This analysis enables the processing device 302 to determine the appropriate command that corresponds to the detected input gesture.

The method 400 concludes at block 412 by transmitting the command to a system of the vehicle. In exemplary embodiments, the processing device 302 converts the determined command into an electrical signal and sends this signal to the appropriate vehicle system 308. The vehicle systems 308 includes various systems such as the turn signal, hazard lights, audio system, air conditioning control unit, and more. The transmitted command allows the driver to control these systems through the touch and gesture inputs detected by the first touch panel 104-1, enhancing the overall driving experience by enabling quick and accurate execution of commands without diverting attention from driving.

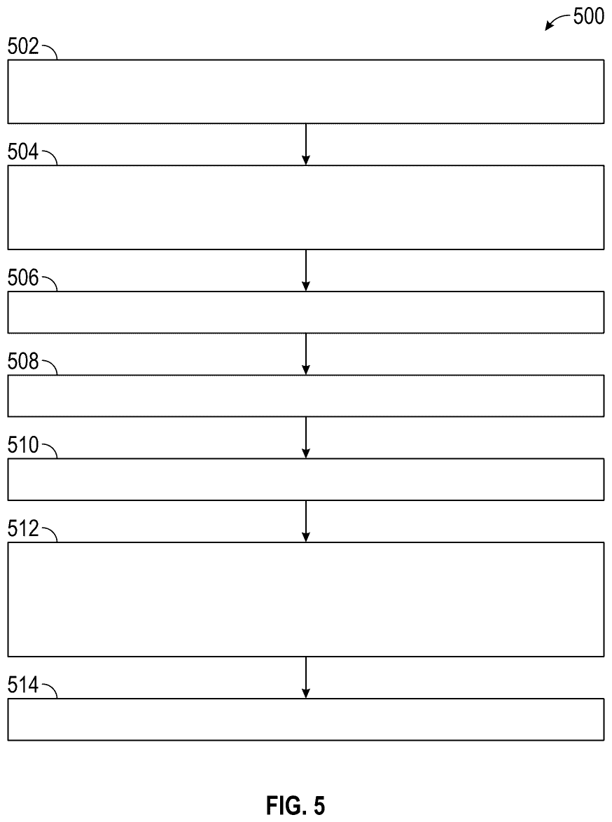

Referring now to FIG. 5, a flowchart diagram of a method 500 for controlling a system of a vehicle using gesture input panels integrated into a steering wheel in accordance with an exemplary embodiment is shown. The method 500 begins at block 502 by detecting a first input gesture on a first touch panel on the steering wheel of a vehicle. In exemplary embodiments, the first touch panel 104-1 is integrated into the steering wheel 102 and is designed to detect various touch and gesture inputs from the driver. These inputs can include taps, swipes, and pressure-based gestures. The first touch panel 104-1 communicates the detected input gesture to the processing device 302 for further processing and execution of commands.

The method 500 continues at block 504 by detecting a second input gesture on a second touch panel on the steering wheel of a vehicle, where the first input gesture and the second input gesture are simultaneously detected. In exemplary embodiments, the second touch panel 104-2 is also integrated into the steering wheel 102 and is designed to detect various touch and gesture inputs from the driver. Similar to the first touch panel 104-1, the second touch panel 104-2 can detect taps, swipes, and pressure-based gestures. The second touch panel 104-2 communicates the detected input gesture to the processing device 302 for further processing and execution of commands. The simultaneous detection of input gestures on both the first touch panel 104-1 and the second touch panel 104-2 allows for more complex and combined input commands, enhancing the driver's control over the vehicle's systems.

Next, at block 506, the method 500 includes determining the operating condition of a vehicle. The processing device 302 receives data from various sensor(s) 306 integrated into the vehicle to determine the operating condition of the vehicle. These sensors 306 monitor real-time data such as vehicle speed, engine status, location, and other operational parameters. The processing device 302 uses this data to determine the current operating condition of the vehicle, which is necessary for contextually appropriate command execution.

At block 508, the method 500 includes determining the identity of the driver of the vehicle. Once the driver's identity is determined, the method 500 includes obtaining a user profile for the driver, at block 510. In exemplary embodiments, the memory 304 stores user profiles that include mappings between various touch and gesture inputs and their corresponding commands. The processing device 302 retrieves the user profile associated with the identified driver. This user profile allows the system to customize the touch and gesture input behavior based on the driver's preferences and habits.

At block 512, the method 500 includes determining a command corresponding to a combination of the first input gesture and the second input gesture based on one or more of a type of the first and second input gestures, the operating condition of the vehicle, and the user profile. The processing device 302 analyzes the first and second input gestures detected by the first touch panel 104-1 and the second touch panel 104-2, taking into account the current operating condition of the vehicle and the retrieved user profile. This analysis enables the processing device 302 to determine the appropriate command that corresponds to the detected input gestures.

The method 500 concludes at block 514 by transmitting the command to a system of the vehicle. The processing device 302 converts the determined command into an electrical signal and sends this signal to the appropriate vehicle system 308. The vehicle systems 308 includes various systems such as the turn signal, hazard lights, audio system, air conditioning control unit, and more. The transmitted command allows the driver to control these systems through the touch and gesture inputs detected by the first touch panel 104-1 and the second touch panel 104-2, enhancing the overall driving experience by enabling quick and accurate execution of commands without diverting attention from driving.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a steering wheel having a first touch panel configured to receive touch and gesture inputs from a driver; and
a processing device in communication with the first touch panel, the processing device configured to:
identify a command corresponding to the touch and gesture inputs based on a type of the touch and gesture inputs; and
transmit one or more electrical signals to a vehicle system to execute the command.

2. The vehicle of claim 1, wherein the steering wheel further comprises a second touch panel configured to receive touch and gesture inputs from the driver.

3. The vehicle of claim 2, wherein one or more of the first touch panel and the second touch panel are disposed on a rear surface of the steering wheel.

4. The vehicle of claim 2, wherein the processing device is further configured to identify the command corresponding to the touch and gesture inputs based on the type of the touch and gesture inputs received from both the first touch panel and the second touch panel.

5. The vehicle of claim 1, wherein the processing device is further configured to identify the driver of the vehicle and to responsively obtain a user profile of the driver.

6. The vehicle of claim 5, wherein the processing device is further configured to identify the command corresponding to the touch and gesture inputs based on the user profile.

7. The vehicle of claim 6, wherein the steering wheel further comprises a third touch panel configured to receive biometric information from the driver that is used by the processing device to identify the driver.

8. The vehicle of claim 1, wherein the first touch panel includes a haptic feedback mechanism that is configured to provide tactile feedback to the driver based on the touch and gesture inputs.

9. The vehicle of claim 1, wherein the type of the touch and gesture inputs include at least one of tap, double tap, triple tap, swipe up, swipe down, swipe left, swipe right, tap and hold, and pressure intensity.

10. The vehicle of claim 1, wherein the first touch panel includes a touch grid that is configured to provide the processing device with a location of the touch and gesture inputs on the first touch panel.

11. A method for controlling a system of a vehicle, the method comprising:
obtaining, via a first touch panel disposed in a steering wheel of the vehicle, touch and gesture inputs from a driver;
identifying a command corresponding to the touch and gesture inputs based on a type of the touch and gesture inputs; and
transmitting one or more electrical signals to the system of the vehicle to execute the command.

12. The method of claim 11, wherein the steering wheel includes a second touch panel configured to receive touch and gesture inputs from the driver.

13. The method of claim 12, wherein one or more of the first touch panel and the second touch panel are disposed on a rear surface of the steering wheel.

14. The method of claim 12, wherein the command is identified based on the type of the touch and gesture inputs received from both the first touch panel and the second touch panel.

15. The method of claim 11, further comprising identifying the driver of the vehicle and responsively obtaining a user profile of the driver.

16. The method of claim 15, wherein the command is identified based at least in part on the user profile.

17. The method of claim 16, wherein the steering wheel further comprises a third touch panel configured to receive biometric information from the driver.

18. The method of claim 11, wherein the first touch panel includes a haptic feedback mechanism that is configured to provide tactile feedback to the driver based on the touch and gesture inputs.

19. The method of claim 11, wherein the type of the touch and gesture inputs include at least one of tap, double tap, triple tap, swipe up, swipe down, swipe left, swipe right, tap and hold, and pressure intensity.

20. A vehicle comprising:
a steering wheel having a first touch panel and a second touch panel disposed on a rear surface of the steering wheel, wherein both the first touch panel and the second touch panel are configured to receive touch and gesture inputs from a driver; and
a processing device in communication with the first touch panel and the second touch panel, the processing device configured to:
identify a command corresponding to the touch and gesture inputs based on a type of the touch and gesture inputs; and
transmit one or more electrical signals to a vehicle system execute the command,
wherein the type of the touch and gesture inputs include at least one of tap, double tap, triple tap, swipe up, swipe down, swipe left, swipe right, tap and hold, and pressure intensity.
